(19) United States
(12) Patent Application Publication
(10) Pub. No.: US 2010/0169821 A1
(43) Pub. Date: Jul. 1, 2010

(54) LAYOUT SWITCHING DEVICE, SCREEN GENERATING DEVICE FOR MOVING OBJECT,INFORMATION DISPLAY SYSTEM FOR MOVING OBJECT,MOVING OBJECT,AND CONTROL METHOD

(76) Inventors: Teruhisa Masui, Osaka (JP); Osamu Nishida, Osaka (JP); Fumiaki Fujimoto, Osaka (JP)

Correspondence Address: HARNESS, DICKEY & PIERCE, P.L.C., P.O. BOX 8910, RESTON, VA, 20195, US

(21) Appl. No.: 12/451,657

(22) PCT Filed: Jan. 24, 2008
(86) PCT No.: PCT/JP2008/050997

§ 371 Date: Nov. 24, 2009

(30) Foreign Application Priority Data
May 29, 2007 (JP) 2007-142623

(51) Int. Cl. G06F 3/048

(52) U.S. Cl. 715/778

(57) ABSTRACT

In one embodiment of the present invention, a layout switching device includes: a disregard list storage section for storing, for each of display layouts, a disregard list indicating a type of state information which can be disregarded even when the state information is changed; and a disregard list comparing section for judging, in a case where the state information is changed, whether or not a type of the changed state information is indicated in the disregard list by referring to a disregard list which corresponds to a current display layout and is stored in the disregard list storage section. Further, a layout decision section decides a layout after switching, based on the latest state information and a layout decision rule, only in a case where the disregard list comparing section judges that the type of the changed state information is not included in the disregard list. This realizes a layout switching device which is capable of efficiently switching layouts of an information screen shown to an operator of a moving object in accordance with a state of the moving object.

### TECHNICAL FIELD

The present invention relates to a layout switching device. More specifically, the present invention relates to: a layout switching device for switching layouts of an information screen shown to an operator of a moving object, in accordance with a state of the moving object; and a screen generating device for a moving object, a display controlling device for a moving object, an information display system for a moving object, and an moving object each of which includes the layout switching device.

### BACKGROUND ART

An automobile, which is an example of a moving object, includes an instrument cluster for notifying a driver of a running speed, engine revolutions, an operating state of a direction indicator, and the like. Conventionally, such an instrument cluster includes, for example, an analog type meter and an indicator lamp using electric bulbs or LEDs

### (Light Emitting Diodes).

In these years, reliability of a dot-matrix type liquid crystal display device has been improved, whereby such a liquid crystal display device has been used for an instrument cluster of an automobile or the like. By using the dot-matrix type liquid crystal display device, it is possible to freely design a display layout of the instrument cluster, and besides, the display layouts of the instrument cluster can be switched in accordance with situations.

For example, Patent Literature 1 (described later) discloses a display controlling device which selects, from a plurality of pieces of predetermined display information, display information to be displayed and a display layout in accordance with a running state of an automobile, and displays the selected information in the selected layout. Further, the display controlling device disclosed in Patent Literature 1 is capable of changing the display layout, the information to be displayed, and timing of display, in accordance with the user's preference.

In a case where the display layouts are switched from one to another among a plurality of display layouts, it is required to define a layout decision rule (a rule of layout transition) that specifies a condition and a display layout to be displayed under the condition. FIG. 17 is a diagram illustrating an example of description of the layout decision rule. As shown in FIG. 17, the layout decision rule specifies how a conditional expression regarding respective states of sections of the automobile corresponds to a type of the display layout to be selected in a case where the conditional expression is true. In the example, in a case where a rotational position of an ignition key is at “OFF”, an “OFF screen” is selected as the display layout for a display screen of the instrument cluster (hereinafter, referred to as a “instrument-cluster screen”).

FIG. 18 is a block diagram illustrating a functional configuration of a conventional information display system for a moving object. The conventional information display system displays the instrument-cluster screen while switching the display layouts in accordance with such a layout decision rule. As shown in FIG. 18, a conventional information display system 100 for an automobile includes: a rule applying section 101, a working memory 102, a rule storage section 103, a drawing section 104, and a display section 105.

The rule storage section 103 stores the layout decision rule. The rule applying section 101 receives CAN (Controller Area Network) messages including various state information such as a running speed, engine revolutions, an operating state of a direction indicator, and a position of a shift lever, from ECUs (Electronic Control Units) provided in operating sections of the automobile, respectively. Then, the rule applying section 101 decides the display layout based on the received state information and the layout decision rule stored in the rule storage section 103. The working memory 102 temporarily stores intermediate data generated in the display layout decision process by the rule applying section 101.

The drawing section 104 produces an instrument-cluster screen indicating states of the operating sections in accordance with the display layout decided by the rule applying section 101. The display section 105 displays the instrument-cluster screen produced by the drawing section 104.

FIG. 19 is a flowchart illustrating an operation of the conventional information display system 100 for the automobile. As shown in FIG. 19, the rule applying section 101 on standby receives the CAN messages including the various state information from ECUs provided in the sections of the automobile via an in-vehicle LAN (S101). Then, the rule applying section 101 judges whether or not contents of the state information included in the received CAN messages are changed from the same types of contents of the state information which are previously received (S103).

In a case where it is judged that the contents of the state information are not changed from the previously received contents, the process returns to the step S101. Whereas, in a case where it is judged that the contents of the state information are changed from the previously received contents, the rule applying section 101 decides the display layout based on the latest state information and the layout decision rule stored in the rule storage section 103 (S105).

Further, the rule applying section 101 judges whether or not there is a further change in contents of the state information in CAN messages which are newly received while the rule applying section 101 is performing a process of the step S105 (S107). The following describes a reason why the step S107 is carried out.

In a case where, for example, approximately 100 conditional expressions are included in the layout decision rule, it may take 3 ms or more for carrying out the process of the step S105. On the other hand, the CAN messages which include the engine revolutions and the running speed reach the rule applying section 101 every 2 ms from the ECUs provided in the respective sections. In such a case, the contents of the state information (in this case, the engine revolutions and the running speed) may be changed before and after the step S105. Accordingly, it is checked whether or not the state information is changed again, after the display layout is decided in the step S105.

In a case where the state information is judged to be changed in the step S107, the process returns to the step S105 and the rule applying section 101 retries the decision process of the display layout based on the layout decision rule. On the other hand, in a case where the state information is not judged to be changed in the step S107, the rule applying section 101 sends the drawing section 104 a layout identifier indicating a type of the display layout decided in the step S105.

The drawing section 104, which has received the identifier, produces an instrument-cluster screen in which partial images indicating the various state information are arranged based on the display layout indicated by the layout identifier, and the display section 105 displays the instrument-cluster screen (S109).

After the step S109, it is judged whether or not a power supply is instructed to be turned “OFF” (S111). In a case where the power supply is not instructed to be turned “OFF”, the process returns to the step S101; whereas, in a case where the power supply is instructed to be turned “OFF”, the process is ended.

Note that FIG. 17 shows a simplified example of the layout decision rule. In practice, the layout decision rule can be described in various ways. More specifically, as shown in FIG. 20, there are four description methods in view of: whether the layout decision rule is defined so as to be common to all display layouts or the layout decision rule is defined for each of current display layouts before switching; and whether only a judgment condition is defined for deciding the display layout or an application order of the judgment condition is also defined in addition to the judgment condition.

Note that the application order of the judgment condition is an order for defining which layout decision rule is adopted first regarding a certain condition, among layout decision rules which apply to any of a plurality of conditions, i.e., layout decision rules which conflict with each other.

The following describes examples of the layout decision rules which conflict with each other. In the example, it is assumed that the following layout decision rules (a) and (b) apply to state information of an automobile whose running speed is 30 km/h and a gear is shifted into “D” (drive):

(a) IF (the running speed is 10 km/h or more AND the gear is “D”) THEN (the screen is switched to a normal running screen);
(b) IF (the running speed is 30 km/h or more) THEN (the display is switched to a medium-speed running screen).
Because both the layout decision rules (a) and (b) apply to the state information in this case, the display layout becomes different depending on the layout decision rule that is adopted first. Therefore, for such state information, it is required to define the application order of the layout decision rules (a) and (b).

With a method of (1) shown in FIG. 20, i.e., with a method in which the layout decision rule is produced for each of the display layouts and only the judgment condition is defined in each of the layout decision rules, the layout decision rule can be described in a relatively easy way. However, the application order of the judgment condition is to be controlled by the rule applying section 101. This causes a problem such that, in a case where the application order is decided by a simple way, one condition is judged needlessly many times or unnecessary judgment is carried out before a conclusion is reached.

Similarly, with a method of (3) shown in FIG. 20, i.e., with a method in which (i) a single layout decision rule, which can be used commonly to all the display layouts, is produced and (ii) only the judgment condition for the layout decision rule is defined, the application order of the judgment condition is to be controlled by the rule applying section 101 although the layout decision is described in an easy way. This cannot achieve a high execution efficiency, in a case where the application order of the judgment condition is decided in a simple way.

Note that, according to the methods of (1) and (3) shown in FIG. 20, a technique for causing the rule applying section 101 to efficiently apply the judgment condition to a current state of the automobile is studied in the field of expert system. As the technique, for example, the Rete algorithm is known.

On the other hand, according to a method of (2) shown in FIG. 20, i.e., according to a method in which (i) the layout decision rule is produced for each of the display layouts and (ii) the judgment condition and the application order thereof are defined in each of the layout decision rules, the rule applying section 101 even in a simple design may efficiently perform a process of selecting a display layout in a case where the layout decision rule is successfully described. However, because the description of the layout decision rule becomes complicated, it is difficult to describe the layout decision rule.

Further, according to the method of (4) shown in FIG. 20, i.e., according to the method in which (i) a single layout decision rule, which can be used commonly to all the display layouts, is produced and (ii) the judgment condition and the application order thereof are defined in the layout decision rule, no unnecessary judgment regarding a condition is carried out, whereby the display layout can be decided efficiently. That is, the switching process of the display layout can be carried out comparatively efficiently with a simple rule processing system.

Patent Literature 1

Japanese Patent Application Publication, Tokukaihei, No. 11-311545 A (Publication Date: Nov. 9, 1999)

### SUMMARY OF INVENTION

However, the conventional techniques have a problem in that the display layouts cannot be switched efficiently. More specifically, in the conventional information display system for an automobile, in a case where state information is judged to be changed in the step S103, a decision process of a display layout after switching in the step S105 is always carried out. However, the change of the state information does not necessarily require switching of the display layouts. That is, in a case the state information is changed, a display layout which is the same as the current display layout may be selected as a result of decision of the display layout after switching.

It takes a long time for carrying out the decision process of the display layout after switching. Accordingly, in a case where a change of state which really requires switching of the display layouts occurs while such an unnecessary process is being carried out, switching of the display layouts will be delayed.

The present invention is accomplished in view of the problem, and an object thereof is to provide (i) a layout switching device which is capable of efficiently switching information screens shown to an operator of a moving object, in accordance with a state of the moving object, and (ii) a screen generating device for a moving object, (iii) an information display system for a moving object, and (iv) a moving object each of which includes the layout switching device.

In order to attain the object, the layout switching device of the present invention is a layout switching device for switching, in accordance with a state of a moving object, layouts of an information screen shown to an operator of the moving object, including: a state information acquiring means for acquiring state information indicating the state of the moving object; a state change judgment means for judging whether or not the state information is changed, every time the state information acquiring means acquires the state information; a type information storage section for storing, for each of the layouts, type information indicating a type of the state information; a switching necessity judgment means for judging, based on whether or not a type of changed state information is included in the type information corresponding to a current layout, whether or not switching of the layouts is required, in a case where the state change judgment means judges that the state information is changed, the type information corresponding to the current layout being stored in the type information storage section; a rule storage section for storing a layout decision rule for deciding a layout based on the state information; and a layout decision means for deciding the layout after switching, in a case where the switching necessity judgment means judges that switching of the layouts is required, the layout being decided based on (i) the state information acquired by the state information acquiring means and (ii) the layout decision rule stored in the rule storage section.

Moreover, in order to attain the object, the control method of the present invention is a control method of a layout switching device for switching, in accordance with a state of a moving object, layouts of an information screen shown to an operator of the moving object, the control method including the steps of: acquiring, by a state information acquiring means of the layout switching device, state information indicating the state of the moving object; judging, by a state change judgment means of the layout switching device, whether or not the state information thus acquired is changed, every time the state information is acquired in the step of acquiring the state information; judging, by a switching necessity judgment means of the layout switching device, whether or not switching of the layouts is required, based on whether or not a type of changed state information is included in type information corresponding to a current layout, in a case where the state information is judged to be changed in the step of judging state change, the type information (i) indicating a type of the state information and (ii) being stored in a type information storage section for storing, for each of the layouts, the type information; and deciding, by a layout decision means of the layout switching device, a layout after switching, in a case where it is judged, in the step of judging necessity of switching, that switching of the layouts is required, the layout being decided based on (i) the state information acquired in the step of acquiring the state information and (ii) a layout decision rule for deciding, based on the state information, the layout after switching, the layout decision rule being stored in a rule storage section for storing the layout decision rule.

The layout switching device of the present invention switches the layouts of the information screen in accordance with a running state of the moving object when the information screen shows, for example, a running speed of the moving object.

According to the configuration, the layout switching device includes the type information storage section for storing, for each of the layouts, the type information indicating the type of the state information. Further, the layout decision means decides the layout after switching, based on the acquired state information and the layout decision rule, in cases where (I) the state change judgment means (the state change judging step) judges that the state information is changed, and also (II) the switching necessity judgment means (the switching necessity judging step) judges that switching of the layouts is required, based on whether or not a type of the changed state information is included in the type information corresponding to the current layout.

Accordingly, in a case where switching of the layouts is judged to be unnecessary based on the type information stored in the type information storage section, a new decision process of the layout is not carried out even when the state information is changed. This makes it possible to omit an unnecessary process, whereby the layouts of the information screen can be switched efficiently.

Note that the type information stored in the type information storage section is sufficient as long as the switching necessity judgment means can judge, based on the type information, whether or not switching of the layouts is required. More specifically, the type information may be either (a) information indicating a type of state information for which switching of the layouts is not required even when the state information is changed or (b) information indicating a type of state information for which switching of the layouts is required when the state information is changed.

However, it is preferable that: the type information storage section stores, for each of the layouts, type information indicating a type of state information for which switching of the layouts is not required; and the switching necessity judgment means judges that switching of the layouts is required, in a case where the type of the changed state information is not included in the type information corresponding to the current layout.

As described above, the type information may include the two types (a) and (b). In general, the number of pieces of the state information corresponding to the type information tends to become smaller, in a case where the type (a) is used as the type information. This makes it possible to quickly obtain a result as to whether or not the type of the changed state information is included in the type information. According to the configuration, the type (a) is used as the type information, whereby the switching process of the layouts can be carried out more efficiently.

Note that it is preferable that: the layout decision rule is data in a tree structure; the tree structure includes a root node and an intermediate node each of which indicates a condition of transition to a child node based on the state information; the tree structure includes a leaf node which indicates a type of the layout after switching; and the layout decision means decides the layout after switching by tracing the tree structure from the root node to the leaf node in accordance with the condition of transition indicated by each of the root node and the intermediate node, with use of the state information acquired by the state information acquiring means.

According to the configuration, the layout after switching is decided by tracing the tree structure from the root node to the leaf node in accordance with the transition condition, with use of the state information acquired by the state information acquiring means. As such, according to the layout decision rule of the tree structure, the application order of the judgment condition is also defined with use of a parent-child relation of the nodes, whereby no unnecessary judgment is repeated and the display layout can be decided efficiently.

Moreover, it is preferable that the layout switching device further includes: a basis information storage section; a basis information producing means; and a disregard information producing means, wherein: the basis information producing means (i) produces a basis information list indicating respective types of state information which are referred to in the root node and the intermediate node, when the tree structure is traced from the root node to the leaf node, and (ii) stores the basis information list thus produced in the basis information storage section, in association with the type of the layout, the type of the layout being indicated by the leaf node; the disregard information producing means (i) excludes, from all types of state information which the state information acquiring means is capable of acquiring, the respective types of state information which are included in the basis information list stored in the basis information storage section, thereby producing a disregard information list which indicates a type of state information for which switching of the layouts is not required even when the state information is changed, and (ii) stores, as the type information, the disregard information list thus produced in the type information storage section, in association with the type of the layout, the type of the layout being associated with the basis information list; and the switching necessity judgment means judges that switching of the layouts is required, in a case where the type of the changed state information is not included in the type information corresponding to the current layout.

In a case where the tree-structured data is used as the layout decision rule, transition conditions, which are indicated by respective nodes on a route connecting a certain leaf node with a root node, are determined for selecting a layout indicated by the certain leaf node. Accordingly, a change of the state information which is referred to for the determination in each of the nodes on the route may lead to a change of the type of the layout which is ultimately selected. On the other hand, regarding state information which is not referred to for the determination in each of the nodes on the route, the change of the state information does not lead to the change of the type of the layout which is ultimately selected.

According to the configuration, the basis information producing means produces the basis information list which indicates the type of the state information used for the determination in each of the nodes on the route. Further, the type of the state information included in the basis information list is excluded from all types of state information which the state information acquiring means is capable of acquiring, whereby it is possible to produce a disregard information list indicating a type of the state information for which switching of the layouts is not required even when the state information is changed.

Moreover, the screen generating device for moving object of the present invention includes: any one of the layout switching devices which further includes an identifier outputting means for outputting an identifier indicating the type of the layout after switching, the layout after switching being decided by the layout decision means; and a screen generating means for acquiring the identifier which is outputted by the identifier outputting means of the layout switching device, thereby generating the information screen so that the information screen has a layout corresponding to the identifier thus acquired.

In the configuration, the layout switching device is included in the screen generating device for the moving object. Accordingly, it is possible to provide the screen generating device for the moving object which can efficiently change the layout of the information screen in accordance with a state of the moving object.

Moreover, the information display system for the moving object of the present invention includes: the screen generating device for the moving object; and a display device for displaying the information screen generated by the screen generating means of the screen generating device for the moving object.

In the configuration, the screen generating device for the moving object is included in the information display system for the moving object. Accordingly, it is possible to provide the information display system for the moving object which is capable of showing the information screen to an operator of the moving object while rapidly switching the layouts in accordance with the state of the moving object.

Moreover, the moving object of the present invention includes the information display system for the moving object, and the display device is provided in a position that is visible from an operator's seat of the moving object.

In the configuration, the information display system for the moving object is included in the moving object. Accordingly, it is possible to provide the moving object which is capable of showing the information screen to the user while rapidly switching the layouts in accordance with the state of the moving object.

Note that, the layout switching device may be realized either by hardware or by causing a computer to run a program. More specifically, a program of the present invention is a program which causes a computer to operate as all of the means of the layout switching device. Further, a storage medium of the present invention stores the program.

When the program is run by the computer, the computer serves as the means of the layout switching device, thereby providing an effect similar to the layout switching device.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating a schematic configuration of an automobile, according to an embodiment of the present invention.

FIG. 2 is a view illustrating examples of display layouts of an information screen, according to the embodiment of the present invention.

FIG. 3 is a diagram illustrating an example of a layout decision rule stored in a rule storage section, according to the embodiment of the present invention.

FIG. 4 is a diagram illustrating an example of a layout decision rule which is more complex than that shown in FIG. 3, according to another embodiment of the present invention.

FIG. 5 is a diagram illustrating an example of a layout decision rule which is more complex than that shown in FIG. 4, according to yet another embodiment of the present invention.

FIG. 6 is a diagram illustrating an example of a disregard list corresponding to a “backward-running screen”, according to the embodiment of the present invention.

FIG. 7 is a flowchart illustrating a first half of an operation of the layout switching device, according to the embodiment of the present invention.

FIG. 8 is a flowchart illustrating a last half of the operation of the layout switching device, according to the embodiment of the present invention.

FIG. 9 is a diagram illustrating a layout decision rule as a binary tree.

FIG. 10 is a diagram illustrating a basis list corresponding to a “screen 4” shown in FIG. 9.

FIG. 11 is a diagram illustrating an example of a basis list corresponding to a “backward-running screen”, according to the embodiment of the present invention.

FIG. 12 is an explanatory diagram illustrating a method for producing a disregard list.

FIG. 13 is a schematic diagram illustrating a structure of a layout decision rule.

FIG. 14 is a diagram illustrating a data structure of a stack used for producing a basis list, according to the embodiment of the present invention.

FIG. 15 is a flowchart illustrating an operation for producing a basis list by a disregard list producing section, according to the embodiment of the present invention.

FIG. 16 is a diagram illustrating an example of a layout decision rule having a network structure, according to yet another embodiment of the present invention.

FIG. 17 is a diagram illustrating an example of a simple layout decision rule, according to a conventional technique.

FIG. 18 is a block diagram illustrating a functional structure of a conventional information display system for a moving object.

FIG. 19 is a flowchart illustrating an operation of a conventional information display system for an automobile.

FIG. 20 is a table illustrating types and features of layout decision rules.

### REFERENCE SIGNS LIST

1: Automobile (Moving Object)
10: Layout Switching Device
12: State Change Judgment Section (State Information Acquiring Means, State Change Judgment Means)
13: Disregard List Comparing Section (Switching Necessity Judgment Means)
14: Layout Decision Section (Layout Decision Means, Identifier Outputting Means)
15: Working Memory (Basis Information Storage Section)
16: Disregard List Storage Section (Type Information Storage Section)
17: Rule Storage Section
18: Disregard List Producing Section (Basis Information Producing Means, Disregard Information Producing Means)
21: Drawing Section (Screen Generating Means)
31: Liquid Crystal Display Device (Display Device)
51: ECU
52: CCD Camera

### DESCRIPTION OF EMBODIMENTS

1. Schematic Configuration

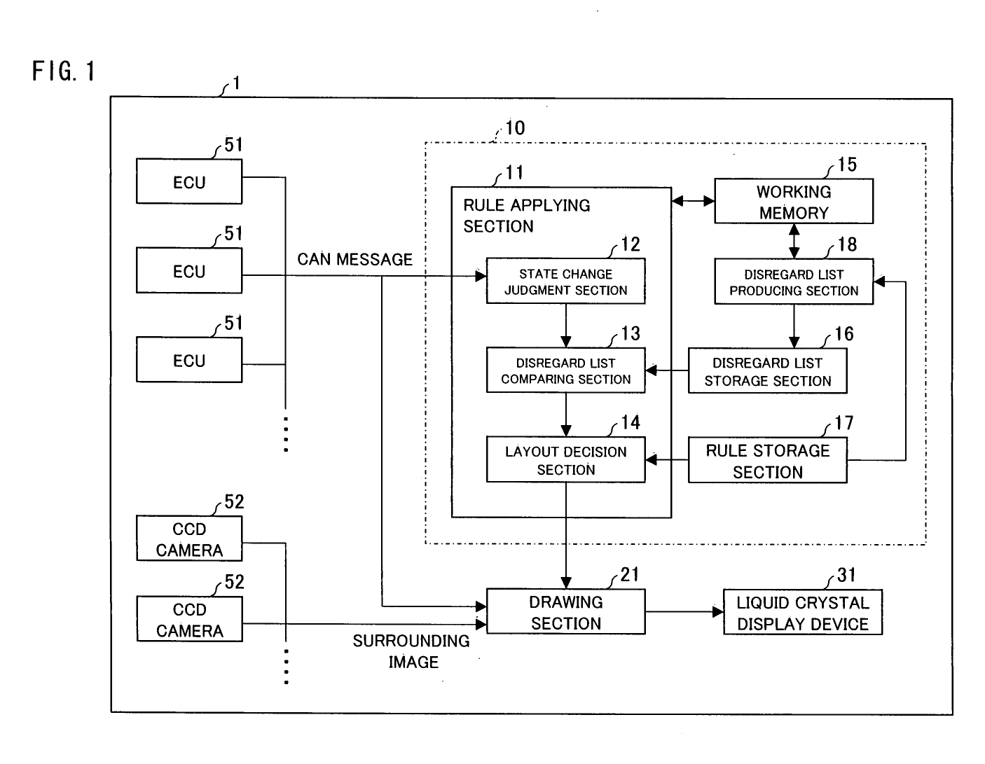

The following describes an embodiment of the present invention with reference to FIGS. 1 to 16. The present embodiment describes an example in which the present invention is applied to an automobile. However, application of the present invention is not limited to an automobile, but the present invention can be applied to various kinds of vehicles (transportation means or transfer means) such as a two-wheeled motor vehicle, a three-wheeled motor vehicle, a railway vehicle, an amphibious vehicle, an airplane, and a ship. Further, other than such vehicles, the present invention can be applied to a virtual vehicle such as a simulator for simulation of operations of the various kinds of vehicles. In the present invention, the various vehicles including the virtual vehicles are collectively referred to as a moving object.

FIG. 1 is a block diagram illustrating a schematic configuration of an automobile 1 of the present embodiment. As shown in FIG. 1, the automobile 1 includes: a layout switching device 10; a drawing section (a screen generating means) 21; a liquid crystal display device (display device) 31; a plurality of ECUs 51 . . . ; and a plurality of CCD cameras 52 . . . . The layout switching device 10 and the drawing section 21 constitute an information screen generating device (a screen generating device for a moving object), and the information screen generating device and the liquid crystal display device 31 constitute an information display system (an information display system for a moving object).

The ECUs 51 . . . are provided in respective operating sections of the automobile 1, and collect information indicating states of the respective operating sections. More specifically, the ECUs 51 . . . collect information such as: engine revolutions of the automobile 1; a running speed; a rotational position of an ignition key; a selected position of a shift lever for operating a gear shifter; an operating state of a direction indicator; lighting states of lights; open/close states of a door and a trunk; a locking state of a door; states of tires; abnormality of an air-bag; a buckled/unbuckled state of a seatbelt; a temperature of the air blown from an air conditioner; an in-car temperature; an ambient air temperature; a state of in-vehicle audiovisual equipment; a setting of an automatic steering system; an operating state of a wiper; a remaining amount of fuel; a remaining amount of a battery; a dependence level between an engine and a battery (in a case of a hybrid vehicle); a remaining amount of oil; a temperature of a radiator; and a temperature of an engine. Hereinafter, the information collected by each of the ECUs 51 . . . is referred to as “state information”.

The CCD cameras 52 . . . are camera devices each provided in each part of a body of the automobile 1. The CCD cameras 52 . . . take and obtain an image in front of the automobile 1, an image on the right in front of the automobile 1, an image on the left in front of the automobile 1, an image behind the automobile 1, an image on the right at the back of the automobile 1, an image on the left at the back of the automobile 1, and the like.

The liquid crystal display device 31 is a dot-matrix type liquid crystal display device which is provided in a position that is visible for a driver (operator) in an operator's seat of the automobile 1. More specifically, for example, the liquid crystal display device 31 may be provided in a position in which conventionally an instrument cluster is provided. The liquid crystal display device 31 shows, in replacement of the conventional instrument cluster, an information screen for notifying various kinds of information to the driver of the automobile 1. The information screen shows (i) information which has not been indicated by the conventional instrument cluster, for example, a navigation image outputted by car navigation equipment (not illustrated) and surrounding images of the automobile 1 taken by the CCD cameras 52 . . . as well as (ii) images of various kinds of information which has been indicated by a conventional instrument cluster, that is, various kinds of state information which is acquired by the ECUs 51 . . . , for example, the running speed, the engine revolutions, and the operating state of the direction indicator.

The drawing section 21 produces the information screen displayed by the liquid crystal display device 31. The drawing section 21 receives CAN messages from the ECUs 51 . . . via in-vehicle LANs. The CAN messages include the various kinds of state information, such as the running speed, acquired by the ECUs 51 . . . . The drawing section 21 also acquires, from the CCD cameras 52 . . . , the surrounding images of the automobile 1 which is taken by the CCD cameras 52 . . . . Moreover, the drawing section 21 acquires a navigation image from the car navigation equipment (not illustrated). Further, the drawing section 21 generates the information screen by combining, in an appropriate arrangement, instrumental images indicating various kinds of state information, surrounding images of the automobile 1, a navigation image, etc. Then, the liquid crystal display device 31 displays the information screen generated by the drawing section 21.

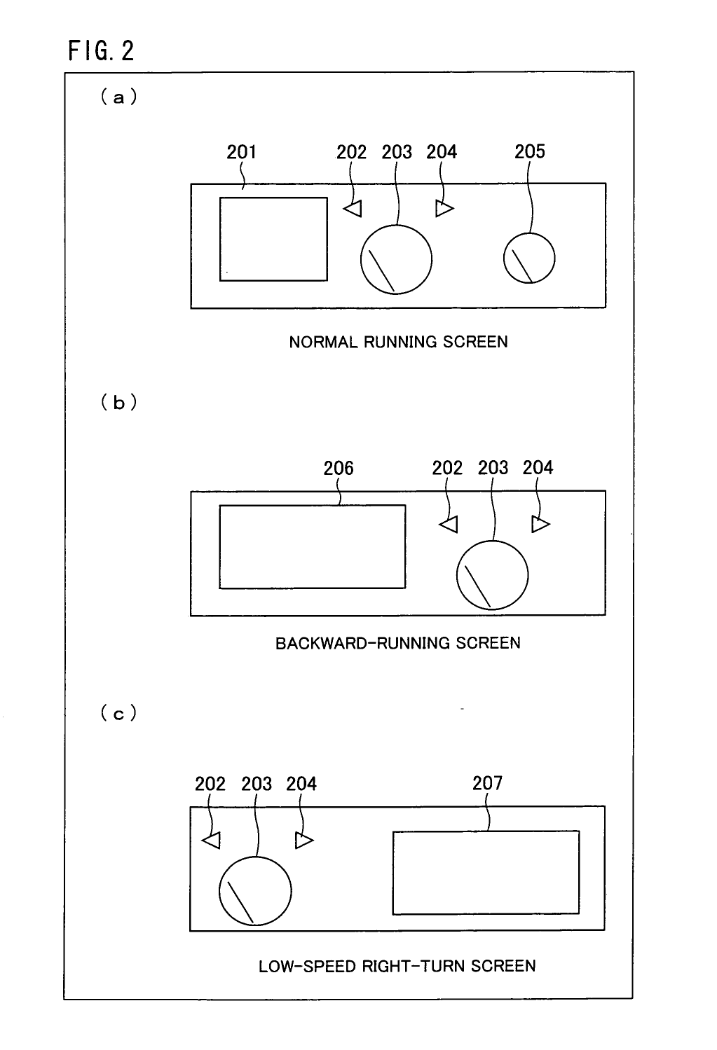

Regarding, for example, the instrumental images indicating various kinds of state information and the surrounding images of the automobile 1, a type and an arrangement (i.e., the display layout) of these images displayed in the information screen are changed in accordance with a running state of the automobile 1. FIG. 2 is a view illustrating examples of the display layout in the information screen. (a) of FIG. 2 illustrates a display layout of the information screen in normal running (hereinafter, referred to as “normal running screen”). In the “normal running screen”, a navigation image 201, a left side direction indicator image 202, a speedometer 203, a right side direction indicator image 204, and a tachometer 205 are arranged in this order from the left.

On the other hand, (b) of FIG. 2 illustrates a display layout in the information screen in backward-running (hereinafter, referred to as “backward-running screen”). In the backward-running screen, a rear image 206 sent from the CCD camera 52 which takes an image behind the vehicle body; the left side direction indicator image 202; the speedometer 203; and the right side direction indicator image 204 are arranged in this order from the left. That is, in the backward-running screen, the rear image 206 is added for showing the driver an image behind the automobile 1, and the navigation image 201 and the tachometer 205 are omitted.

(c) of FIG. 2 illustrates a display layout in the information screen in turning right at a low speed (hereinafter, referred to as “low-speed right-turn screen”). In the “low-speed right-turn screen”, the left side direction indicator image 202, the speedometer 203, the right side direction indicator image 204, and the right rear image 207 sent from the CCD camera 52 which takes an image on the right at the back of the vehicle body are arranged in this order from the left.

As such, in the information display system provided in the automobile 1 in the present embodiment, the type or the arrangement of, for example, the instrumental images and the surrounding images are changed variously in accordance with the running state of the automobile 1 and displayed. That is, the display layouts of the information screen, which is shown to the driver, is switched appropriately in accordance with the running state of the automobile 1.

In such a case, the layout switching device 10 switches the display layouts of the information screen. The layout switching device 10 receives the CAN messages including a plurality of types of the state information from the ECUs 51 . . . , thereby figuring out operating states of the operating sections of the automobile 1. Then, the layout switching device 10 outputs an identifier indicating a type of the display layout (hereinafter, referred to as “layout identifier”) to the drawing section 21, in accordance with the operating state. In the cases of the examples of FIG. 2, the display layouts shown in (a) to (c) of FIG. 2, respectively, are provided with identifiers different from one another.

Then, the drawing section 21 generates an information screen which shows each of the operating states in the display layout corresponding to the layout identifier that is outputted from the layout switching device 10. Further, the information screen generated in this way is displayed by the liquid crystal display device 31. The following describes a configuration of the layout switching device 10 in detail.

2. Configuration of Layout Switching Device

As shown in FIG. 1, the layout switching device 10 includes, as a functional block, a rule applying section 11, a working memory 15, a disregard list storage section (type information storage section) 16, and a rule storage section 17. The rule applying section 11 further includes a state change judgment section (state information acquiring means, state change judgment means) 12, a disregard list comparing section (switching necessity judgment means) 13, and layout decision section (layout decision means, identifier outputting means) 14.

The state change judgment section 12 acquires the CAN messages including the state information collected by the ECUs 51 . . . . Further, every time the state change judgment section 12 acquires the CAN messages, the state change judgment section 12 judges whether or not a content (value) of each state information included in the acquired CAN messages is changed from the same type of content (value) of state information acquired last time. For example, when the state change judgment section 12 acquires a CAN message including information of a selected position of the shift lever, the state change judgment section 12 stores the information of the selected position in the working memory 15. Then, when the state change judgment section 12 newly acquires a CAN message including information of a selected position of the shift lever, the state change judgment section 12 compares the newly acquired information as to the selected position with the previous information stored in the working memory 15 and judges whether or not the selected position of the shift lever is changed. The state change judgment section 12 carries out such a comparison process for all types of state information.

The rule storage section 17 stores the layout decision rule which is similar to the conventional one. The layout decision section 14 decides a display layout after switching, based on (i) the various types of state information included the CAN messages acquired by the state change judgment section 12 and (ii) the layout decision rule stored in the rule storage section 17, and outputs a layout identifier indicating a type of the decided display layout to the drawing section 21.

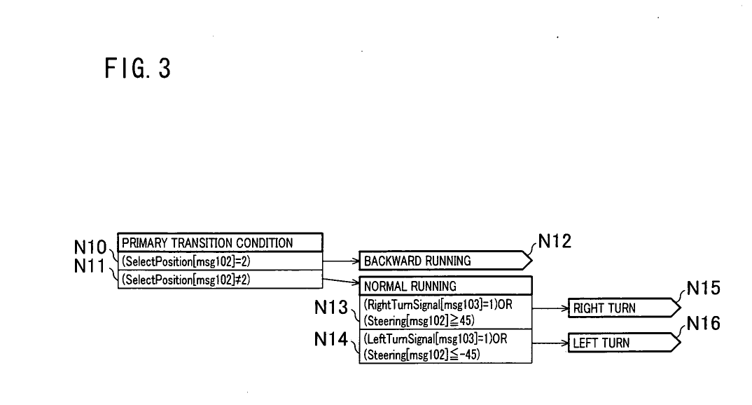

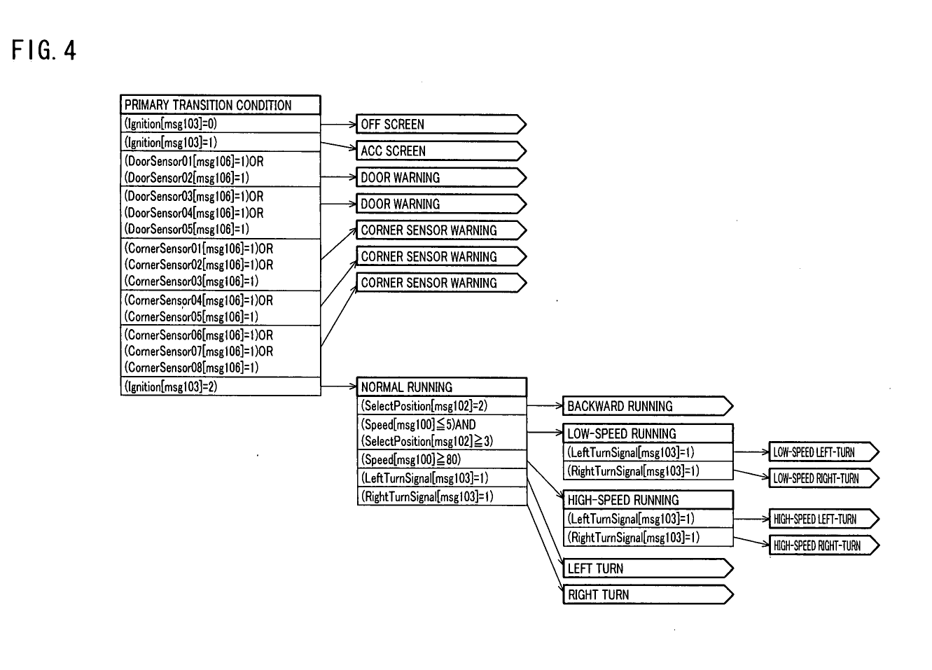

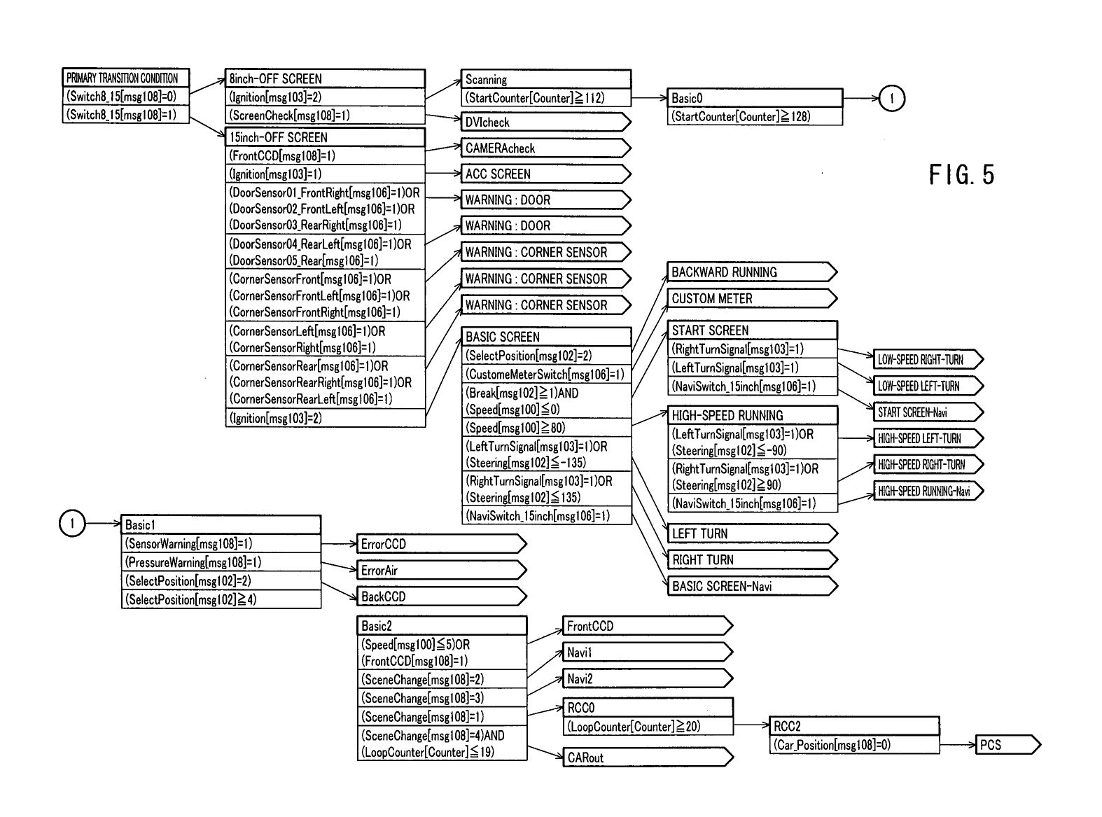

FIGS. 3 to 5 are diagrams each illustrating an example of the layout decision rule stored in the rule storage section 17. FIG. 3 illustrates an example of a simple layout decision rule, FIG. 4 illustrates an example of a layout decision rule which is more complex than that of FIG. 3, and FIG. 5 illustrates an example of a layout decision rule which is more complex than that of FIG. 4.

In the layout decision rule, a judgment expression using the state information is associated with a type of the display layout to be selected in accordance with a judgment result of the judgment expression. In the present embodiment in particular, as shown in FIGS. 3 to 5, the layout decision rule is a single tree structured (binary tree) data commonly applicable to all the display layouts, regardless of the current display layout. Further, in the layout decision rule, judgment conditions and an application order of the judgment conditions are defined. For example, the following describes a decision process of a display layout in a case where the layout decision rule shown in FIG. 3 is used.

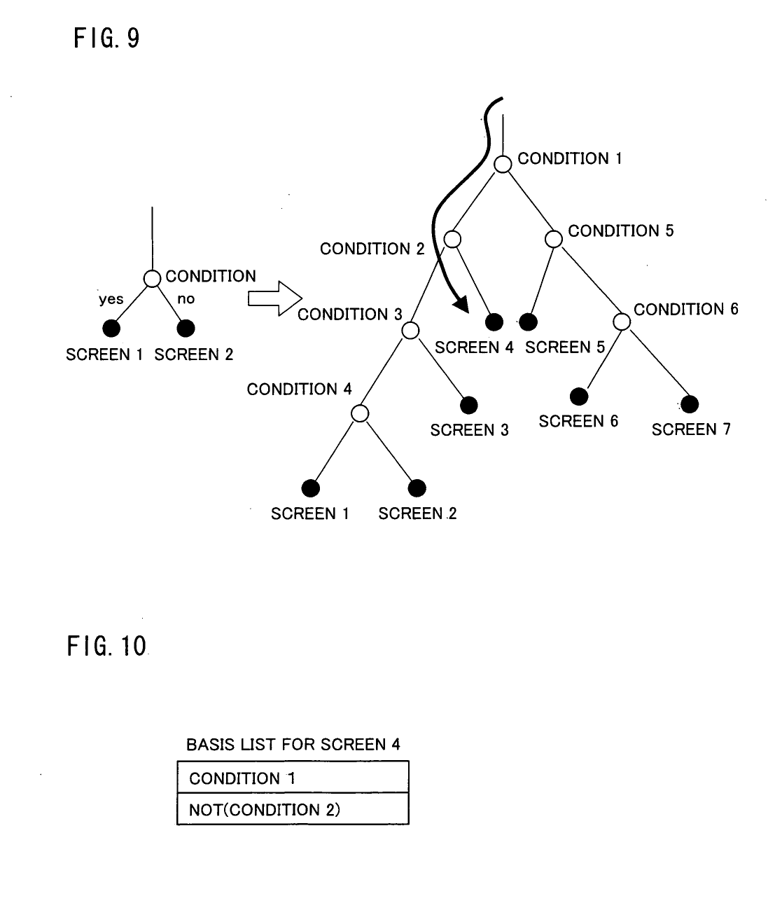

In FIG. 3, a node N10 is a root node (a top node), and nodes N11 and N12 are child nodes to the root node N10. Further, a node N13 is a child node to the node N11; nodes N14 and N15 are child nodes to the node N13; and a node N16 is a child node to the node N14. In this case, the nodes N12, N15, and N16 are leaf nodes. Note that a parent-child relation of the nodes is described later with reference to FIG. 9.

The root node N10 and the nodes N11, N13, and N14, which are positioned between the root node and the leaf nodes (herein after, referred to as “intermediate node”), respectively, indicate conditional expressions each indicating a condition of transition to lower child nodes. Further, each of the leaf nodes N12, N15, and N16 indicates a type of the display layout after switching. The layout decision section 14 judges whether or not each of the conditional expressions indicated by the nodes is true. In a case where the conditional expression is true, an upper child node is selected, whereas a lower child node is selected in a case where the conditional expression is false. The layout decision section 14 decides the display layout after switching, by tracing the tree structure from the root node N10 to any one of the leaf nodes N12, N15, and N16 in accordance with the judgment result of each of the transition conditions. The tracing here is carried out with use of the various types of state information included in the CAN messages acquired by the state change judgment section 12.

Note that, in FIG. 3, a variable “SelectPosition[msg102]” indicates the selected position of the shift lever. In a case where the selected position of the shift lever is “R” for backing the automobile, a value of the variable becomes “2”. Accordingly, in a case where the selected position of the shift lever is “R”, the layout decision section 14 judges that the conditional expression of the root node N10 is true, and shifts the root node N10 to the leaf node N12. Because the leaf node N12 indicates the “backward-running screen” as the type of the display layout, the layout decision section 14 selects the “backward-running screen” as the display layout after switching.

On the other hand, in a case where the selected position of the shift lever is not “R”, the layout decision section 14 judges that the conditional expression of the root node N10 is false, and shifts the root node N10 to the intermediate node N11. In this case, because the conditional expression is always judged to be true in the intermediate node N11, the layout decision section 14 shifts the intermediate node N11 to the intermediate node N13. In the intermediate node N13, it is judged whether or not a conditional expression regarding values of the operating state of the direction indicator and a turning angle of the steering is true. In a case where the conditional expression is judged to be true, the intermediate node N13 is shifted to the leaf node N15 and the “right-turn screen” is selected as the display layout.

Note that, in a case where a conditional expression is judged to be false in the intermediate node N14, the “normal running screen” is selected as the display layout. More specifically, the “backward-running screen” is selected in a case where the conditional expression in the root node N10 is judged to be true. On the other hand, the “normal running screen” is displayed in a case where: (i) the conditional expression in the root node N10 is false; and (ii) the conditional expression in the intermediate node N11 is true; and (iii) the conditional expression in the intermediate node N13 is false; and (iv) the conditional expression in the intermediate node N14 is false. Accordingly, the normal running screen is selected in a case where (i) the selected position of the shift lever is not “R” and (ii) the automobile is not turning right or left.

Moreover, in the present embodiment, when the layout decision section 14 begins a decision process of the display layout after switching, the layout decision section 14 always begins the decision process from the root node N10, regardless of a type of the current display layout. The layout decision rules shown in FIGS. 4 and 5 are used in a similar way to that of FIG. 3.

The following describes a conventional problem. In the conventional configuration, in a case where at least one type of the state information among a plurality of state information included in the CAN messages sent from the ECUs 51 . . . is judged to be changed, the selection process of the display layout after switching is carried out based on the layout decision rule. Accordingly, in the example of FIG. 4, for example, in a case where the operating state of the direction indicator and/or the running speed is changed, the selection process of the display layout is carried out. However, in the case where the display layout is in the “backward-running screen”, the “backward-running screen” is kept as the display layout as shown in FIG. 4 even when the operating state of the direction indicator and the running speed are changed. That is, in the conventional configuration, an unnecessary selection process of the display layout is carried out. As a result, the switching process of the display layout cannot be carried out rapidly.

In order to solve the problem, the layout switching device 10 of the present embodiment includes the disregard list comparing section 13 and the disregard list storage section 16. The disregard list storage section 16 stores, for each of the display layouts, a disregard list (type information) indicating a list of types of state information which can be disregarded (i.e., for which switching of the layouts is not required) even when the state information is changed in each of the display layouts. In other words, the disregard list storage section 16 stores a table in which the disregard list is associated with the types of the display layouts.

The disregard list comparing section 13 specifies a disregard list corresponding to the current display layout among the disregard lists stored in the disregard list storage section 16, in a case where the state change judgment section 12 judges that any of the acquired state information is changed. Then, the disregard list comparing section 13 compares a type of the state information included in the specified disregard list with the type of the changed state information, and judges whether or not the type of the changed state information is included (indicated) in the disregard list. Further, the disregard list comparing section 13 judges whether or not switching of the display layouts is required, based on the judgment result. In the present embodiment in particular, the disregard list comparing section 13 is configured to judge that: switching of the layouts is not required, in a case where the type of the changed state information is included in the disregard list, whereas switching of the layouts is required in a case where the type of the changed state information is not included in the disregard list.

In the example shown in FIG. 4, in the “backward-running screen”, in a case where the operating state of the direction indicator and the running speed are changed, i.e., the state information regarding the operating state and the running speed is changed, it is not required to switch the display layouts. Accordingly, a disregard list corresponding to the “backward-running screen” indicates the types of the state information of the operating state and the running speed.

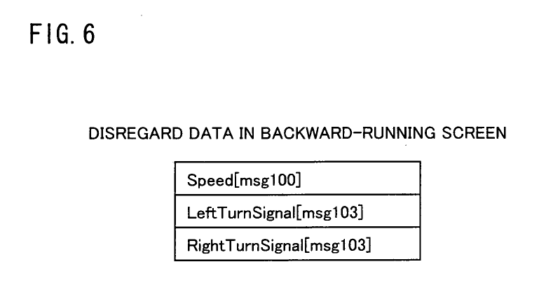

FIG. 6 is a diagram illustrating an example of the disregard list corresponding to the “backward-running screen”. As shown in FIG. 6, the disregard list corresponding to the “backward-running screen” indicates the running speed (“Speed[msg100]”), the left side direction indicator (“LeftTurnSignal[msg103]”), and the right side direction indicator (“RightTurnSignal[msg103]”), among the types of the state information. Accordingly, the disregard list comparing section 13 judges that switching of the layouts is not required, in a case where the type of the changed state information relates to the running speed or the direction indicators. On the other hand, the disregard list comparing section 13 judges that switching of the layouts is required, in a case where the type of the changed state information relates to neither the running speed nor the direction indicators.

Further, the layout decision section 14 is configured to execute the selection process of the display layout after switching, based on the latest state information and the layout decision rule, only in a case where the disregard list comparing section 13 judges that switching of the layouts is required (i.e., in a case where the type of the changed state information is not included in the disregard list).

3. Operation of Layout Switching Device

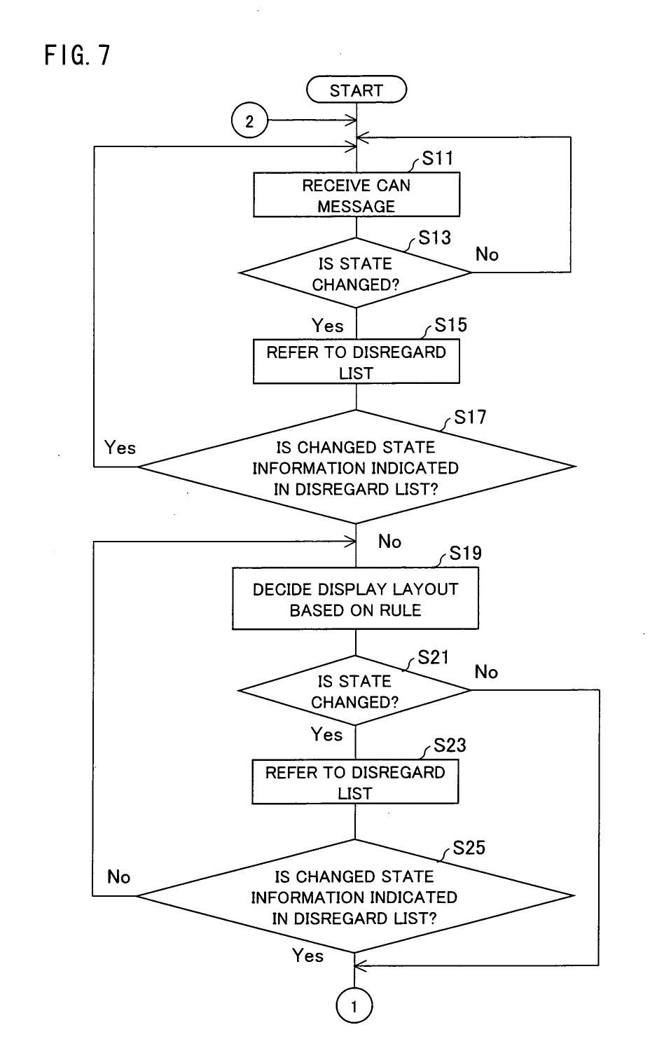

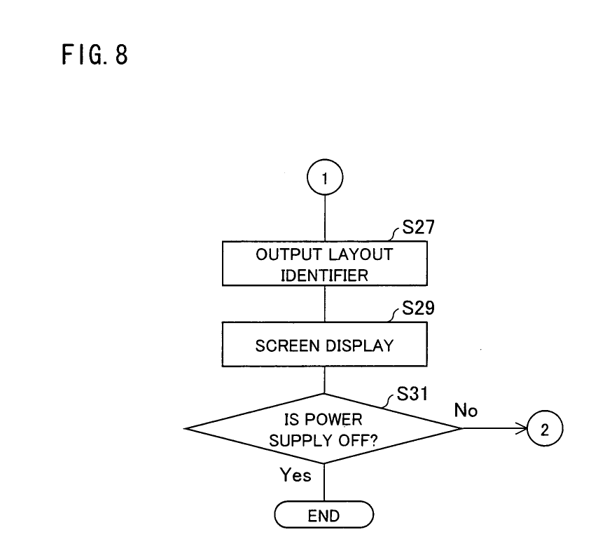

The following describes an operation of the layout switching device of the present embodiment. FIGS. 7 and 8 are flowcharts illustrating the operation of the layout switching device. FIG. 7 illustrates a first half of the operation, and FIG. 8 illustrates a last half of the operation. As shown in FIG. 7, first, the state change judgment section 12 of the layout switching device 10 stays standby until reception of CAN messages from the ECUs 51 . . . , and receives the CAN messages (S11). The CAN messages include a plurality of types of state information. Then, the state change judgment section 12 extracts the state information out of the received CAN messages, and judges whether or not any value of the extracted state information is changed form that of the same type of state information which is previously acquired (S13).

In a case where no state information whose value is changed is found, the process returns to the step S11. Then, the state change judgment section 12 stays standby until next CAN massages are sent. On the other hand, in the step S13, in a case where the state information whose value is changed is found, the disregard list comparing section 13 refers to a disregard list corresponding to the current layout, among the disregard lists stored in the disregard list storage section 16 (S15), and judges whether or not the type of the changed state information is included in the disregard list which is referred to (S17). In a case where the type of the changed state information is included in the disregard list, the change of the state information can be disregarded. Accordingly, the process returns to the step S11.

On the other hand, in a case where the type of the changed state information is not included in the disregard list, the change of the state information cannot be disregarded. Accordingly, the layout decision section 14 decides the display layout after switching, based on (i) the latest state information acquired by the state change judgment section 12 and (ii) the layout decision rule stored in the rule storage section 17 (S19).

Then, it is checked whether or not a running state of the automobile 1 is changed before and after the step S19. More specifically, the state change judgment section 12 judges whether or not the state change judgment section 12 has received, during the process of the step S19, new CAN messages including state information of which value is changed (S21). In a case where the state change judgment section 12 has not acquired state information of which value is changed, the display layout after switching which is decided in the step S19 is regarded as valid. Then, as shown in FIG. 8, the layout decision section 14 sends the drawing section 21 a layout identifier corresponding to the display layout after switching which is decided in the step S19 (S27).

On the other hand, in the step S21, in a case where the state change judgment section 12 has acquired state information of which value is changed, the disregard list comparing section 13 (i) refers to a disregard list corresponding to the display layout after switching which is decided in the step S19 (S23), and (ii) judges whether or not the type of the changed state information is included in the disregard list which is referred to (S25). In a case where the type of the changed state information is included in the disregard list, the change of the state information can be disregarded. Accordingly, the step S27 is carried out. In the step S27, the layout decision section 14 sends the drawing section 21 a layout identifier corresponding to the display layout after switching which is decided in the step S19 (S27).

On the other hand, in a case where the type of the changed state information is not included in the disregard list, the change of the state information cannot be disregarded. Accordingly, the process returns to the step S19, and the layout decision section 14 decides anew the display layout after switching, based on (i) the latest state information and (ii) the layout decision rule stored in the rule storage section 17 (S19).

After the step S27, the drawing section 21 acquires the layout identifier from the layout decision section 14. Then, the drawing section 21 generates an information screen which is synthesized in accordance with the display layout indicated by the acquired layout identifier. Consequently, the liquid crystal display device 31 displays the synthesized information screen (S29). Note that, as described above, the layout identifier is used for describing the state information collected by the ECUs 51 . . . , the surrounding images taken by the CCD cameras 52 . . . , the navigation image, etc., which are included in the display layout. Further, in a case where the power supply is not instructed to be turned “OFF” (i.e., No in S31), the process returns back to the step S11, whereas the process is ended in a case where the power supply is instructed to be turned “OFF”.

In the flowcharts shown in FIGS. 7 and 8, the step S11 corresponds to the step of acquiring the state information; the step S13 corresponds to the step of judging state change; the steps S15 and S17 correspond to the step of judging switching necessity; the step S19 corresponds to step of deciding the layout; and the step S27 corresponds to the step of outputting the identifier.

Note that the disregard list stored in the disregard list storage section 16 may be produced while the switching process of the display layouts is carried out by the layout switching device 10. However, a process time can be reduced by preliminarily producing the disregard list and storing this disregard list in the disregard list storage section 16. The following describes a method for producing the disregard list.

4. Method for Producing Disregard List

A disregard list for each of the display layouts can be produced from the layout decision rule. The following roughly describes a method for producing the disregard list. First, a basis list is produced from the layout decision rule. The basis list indicates, for each of the display layouts, a list of values to be satisfied and each type of state information which are required in condition judgment in each of the nodes. The values and each type of state information are used for selecting each of the display layouts. Further, a type of state information which can be disregarded even when the state information is changed can be obtained by excluding a type of state information included in the basis list from all types of the state information which the ECUs 51 . . . are capable of collecting.

FIG. 9 is a diagram illustrating the layout decision rule as a binary tree. First, the above mentioned parent-child relation of nodes is described. White circles in FIG. 9 indicate judgment conditions. Two black circles connected below each of the white circles indicate results of judgment of a certain state based on the judgment condition. In the structure, the judgment condition indicated by the white circle is a parent node to the results indicated by the black circles, and the results indicated by the black circles are child nodes to the judgment condition indicated by the white circle. Moreover, one of the two child nodes inherits the judgment condition of the parent node as it is, and the other of the two child nodes inherits a negation of the judgment condition of the parent node. Further, in the tree structure as shown in FIG. 9, i.e., in the tree structure including nodes connected with each other in the parent-child relation, a single node which is in the top in the tree structure is referred to as the root node, and each of a plurality of end nodes is referred to as the leaf node.

As shown in the left part of FIG. 9, in a case where the condition indicated by the parent node is satisfied (i.e., in a case where the conditional expression is true), a transition to the left child node is made. On the other hand, in a case where the condition is not satisfied (i.e., in a case where the conditional expression is false), a transition to the right child node is made. Accordingly, in a case where a set of the root node and the leaf nodes is defined as shown in the left part of FIG. 9, a “screen 1” is selected as the display layout when the condition indicated by the root node is satisfied. Meanwhile, when the condition is not satisfied, a “screen 2” is selected.

The right part of the FIG. 9 illustrates a whole layout decision rule in the format as described above. In the example, in order for a “screen 4” to be selected as the display layout, a “screen 4” node needs to be reached from a “condition 1” node through a “condition 2” node. Accordingly, in order for the “screen 4” to be selected, it is a necessary and sufficient condition that the “condition 1” is satisfied and the “condition 2” is not satisfied. From this, as shown in FIG. 10, the basis list of the screen 4 includes two basis data that are “condition 1” and “NOT (condition 2)”.

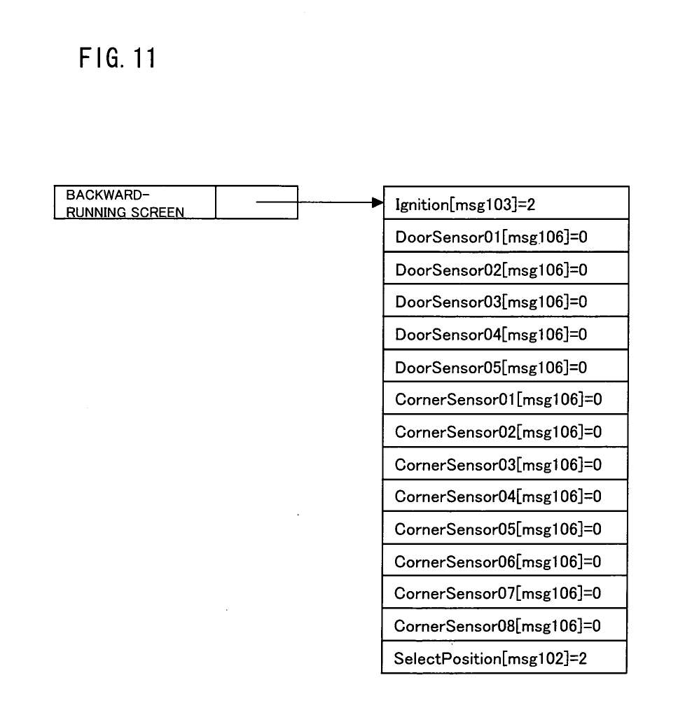

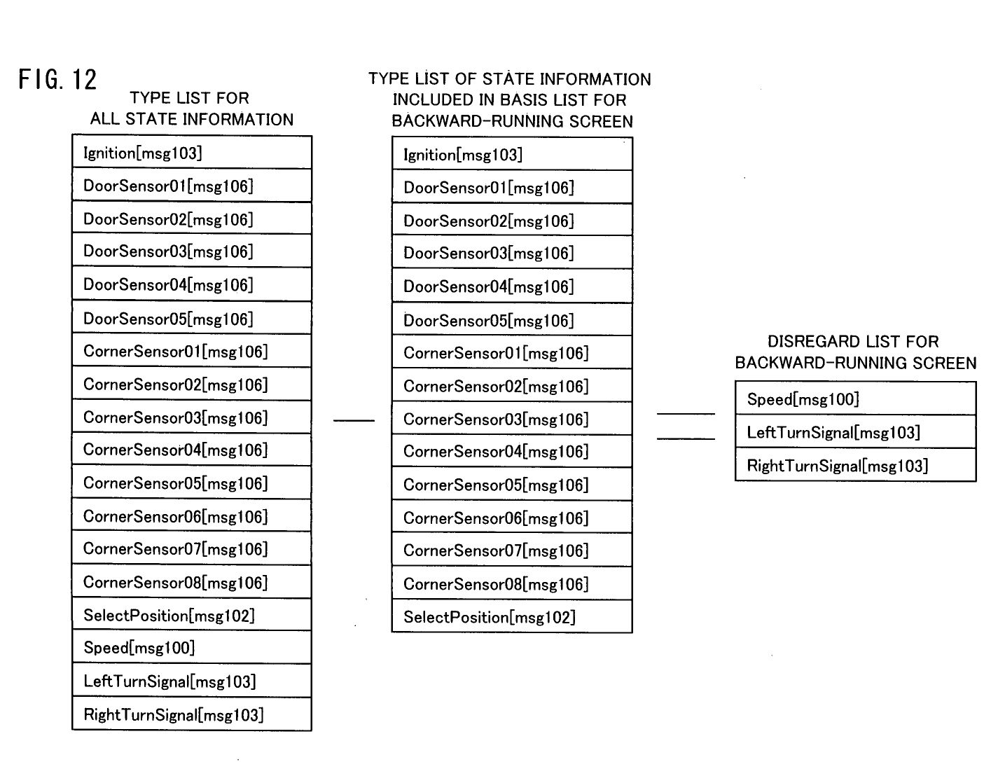

FIG. 11 illustrates a basis list corresponding to the “backward-running screen” in a case where a similar method is applied to the layout decision rule shown in FIG. 4. In order for the “backward-running screen” to be selected out of the basis list, 15 types of state information shown in FIG. 11 are referred to. Further, in a case where the “backward-running screen” is applied as the display layout, the display layout will not be changed from the “backward-running screen” even though state information which is not included in the basis list is changed. Accordingly, as shown in FIG. 12, a disregard list for the “backward-running screen” can be obtained by excluding the types of state information included in the basis list of the “backward-running screen” from all types of state information which can be collected by the ECUs 51 . . . each of which is provided in each of the parts of the automobile 1.

The layout switching device 10 of the present embodiment includes the disregard list producing section (the basis information producing means, disregard information producing means) 18 as the functional block for carrying out the process for producing the basis list and the disregard list. The disregard list producing section 18 refers to the layout decision rule stored in the rule storage section 17, and produces the basis list indicating (a) types of state information referred to for judging each of the transition conditions in tracing the tree structure from the root node to the leaf node and (b) a condition to be satisfied. Further, the disregard list producing section 18 stores the produced basis list in the working memory (basis information storage section) 15, in association with the type of the display layout indicated by the leaf node.

The following describes a method for efficiently producing the basis list from the layout decision rule. In a case where a basis list for each of all the display layouts is exhaustively produced from the layout decision rule, it is preferable that a stack is prepared in the memory and a principle of last in first out is used.

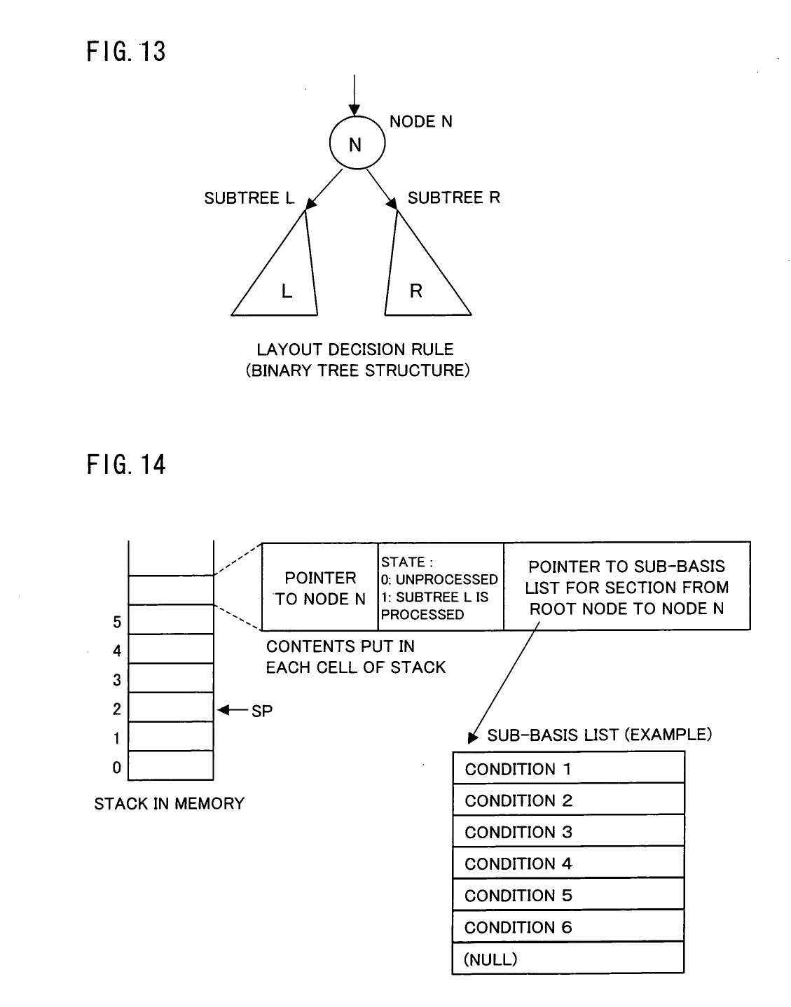

FIG. 13 is a schematic diagram illustrating a structure of the layout decision rule. As described above, the layout decision rule is shown as the binary tree. As shown in FIG. 13, two subtrees are connected to each node. The left subtree of the two subtrees is referred to as a subtree L, and the right subtree is referred to as a subtree R.

FIG. 14 is a diagram illustrating a data structure of the stack used for producing the basis list. As shown in FIG. 14, each stage of the stack includes three cells for storing, respectively, a pointer to a node N, a value of a variable “state” indicating a processing state, and a pointer to a sub-basis list which is temporarily produced for a section from the root node to the node N. The variable “state” takes “0” when the process has not been carried out, whereas the variable “state” takes “1” when the process in the subtree L has been completed.

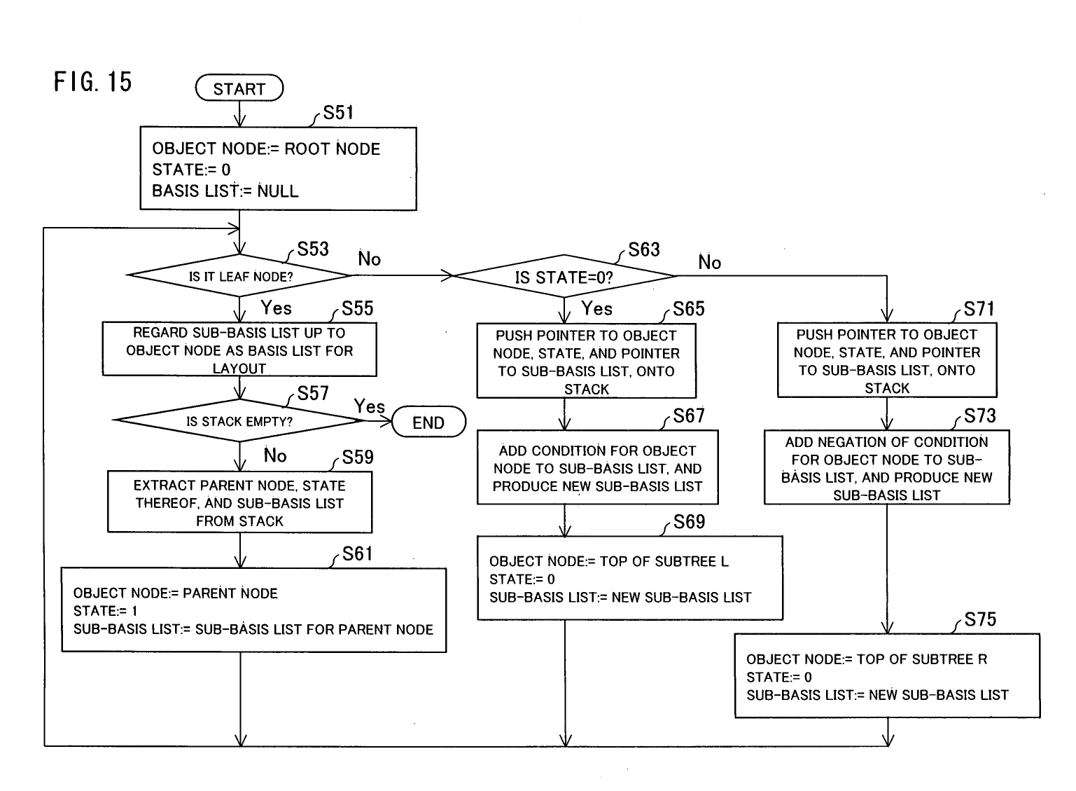

FIG. 15 is a flowchart illustrating an operation for producing the basis list by the disregard list producing section 18. First, the disregard list producing section 18 sets (i) an object node to the root node (top node), (ii) the value of variable “state” to 0, and (iii) the sub-basis list to null (S51). In the following description, unless otherwise noted, the principal section to carry out each of the steps is the disregard list producing section 18.

Then, it is judged whether or not the object node is the leaf node (S53). In a case where the object node is not the leaf node, it is judged whether or not the “state=0” (S63). Further, in a case where the “state=0”, the process proceeds to a step S65. In the step S65, the pointer to the object node, the value of the variable “state” (=0), and the pointer to the sub-basis list are pushed onto the stack of the working memory 15. For example, in a case where the current object node is the root node, the pointer to the root node, the value “0” as the value of the variable “state”, and the pointer to the sub-basis list (null) are pushed on top of the stack.

Further, the disregard list producing section 18 refers to an object node of the layout decision rule stored in the rule storage section 17, and produces a new sub-basis list by adding a conditional expression indicated by the object node to a current sub-basis list (S67). With the step, for example, in a case where the current node is the root node, a sub-basis list including only a conditional expression indicated by the root node is produced. Then, the disregard list producing section 18 sets (i) the object node to a top of the subtree L (i.e., the left child node) and (ii) the value of the variable “state” to “0”, and replaces the sub-basis list with the new sub-basis list produced in the step S67 (S69). Then, the process returns to the step S53.

On the other hand, in a case where it is judged that the “state=0” is false in the step S63, the process proceeds to a step S71. In the step S71, the pointer to the object node, the value of the variable “state” (=1), and the pointer to the sub-basis list are pushed on top of the stack of the working memory 15 (S71). Then, the disregard list producing section 18 refers to an object node of the layout decision rule stored in the rule storage section 17, and produces a new sub-basis list by adding, to a current sub-basis list, a negation of conditional expression indicated by the object node (S73). Then, the disregard list producing section 18 sets (i) the object node to a top of the subtree R (i.e., the right child node) and (ii) the value of the variable “state” to “0”, and replaces the sub-basis list with the new sub-basis list produced in the step S73 (S75). Then, the process returns to the step S53.

In a case where the object node is judged to be the leaf node in the step S53 as a result of repetition of the above process, the process proceeds to a step S55. In the step S55, the sub-basis list produced for the section from the root node to the object node is associated with the type of the display layout indicated by the object node, and the sub-basis list associated with the type is stored in the working memory 15 as a basis list. The basis list which corresponds to the display layout indicated by the leaf node (object node) can be obtained through the steps.

Then, it is judged whether or not the stack is empty by referring to the stack in the working memory 15 (S57). In a case where the stack is not empty, the disregard list producing section 18 extracts the pointer to the parent node, the state, and the pointer to sub-basis list from the top of the stack (S59). This reduces one stage from the stack. Further, the disregard list producing section 18 sets the object node to the parent node indicated by the pointer extracted in the step S59 and the state to “1”, and replaces the sub-basis list with a sub-basis list of the parent node indicated by the pointer extracted in the step S59 (S61). Then, the process returns to the step S53.

In a case where the stack is judged to be empty in the step S57 (in a case where SP=0), the basis list for each of all the display layouts has been completed. Accordingly, the process for producing the basis list is ended.

Then, as shown in FIG. 12, the disregard list producing section 18 produces a disregard list indicating the type of state information for which switching of the layouts is not required even when the state information is changed, by excluding a type of state information included in the basis list stored in the working memory 15 from all types of state information which can be collected by the ECUs 51 . . . each provided in each of the parts. Further, the disregard list producing section 18 stores the produced disregard list in the disregard list storage section, in association with the type of the display layout corresponding to the basis list. The disregard list producing section 18 carries out the operation on all the display layouts, thereby producing the disregard list for each of all the display layouts.

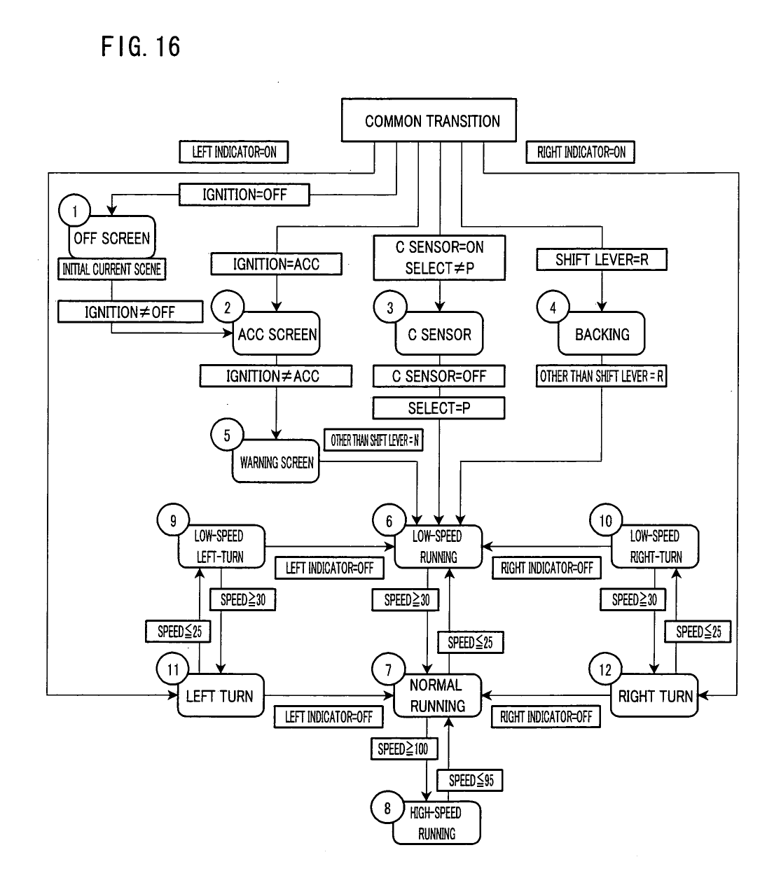

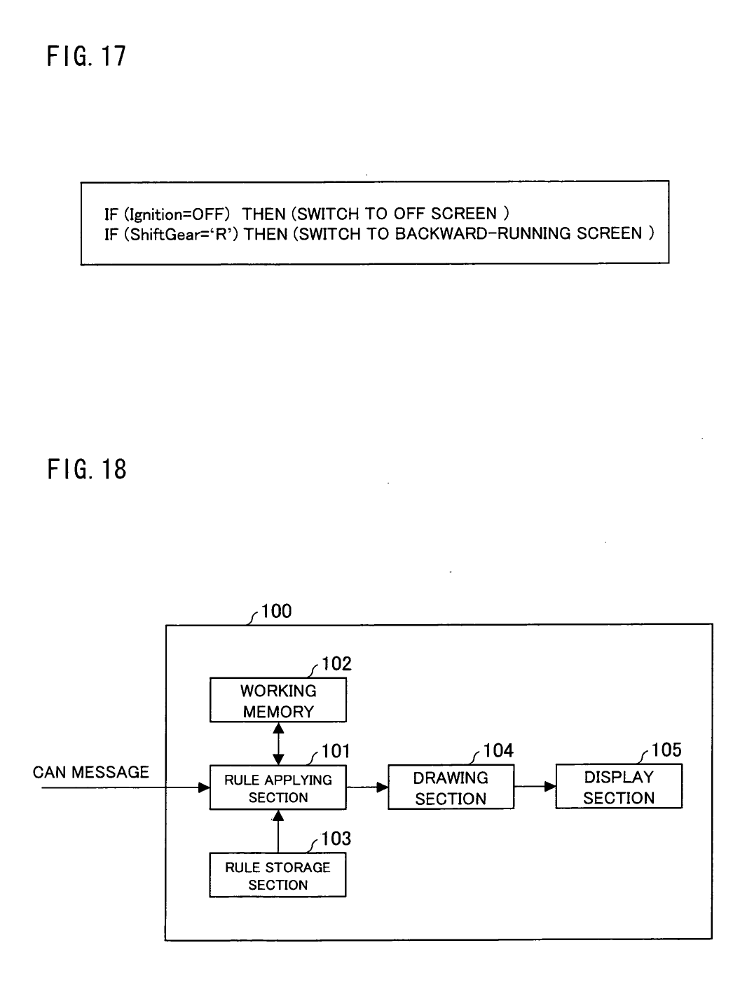

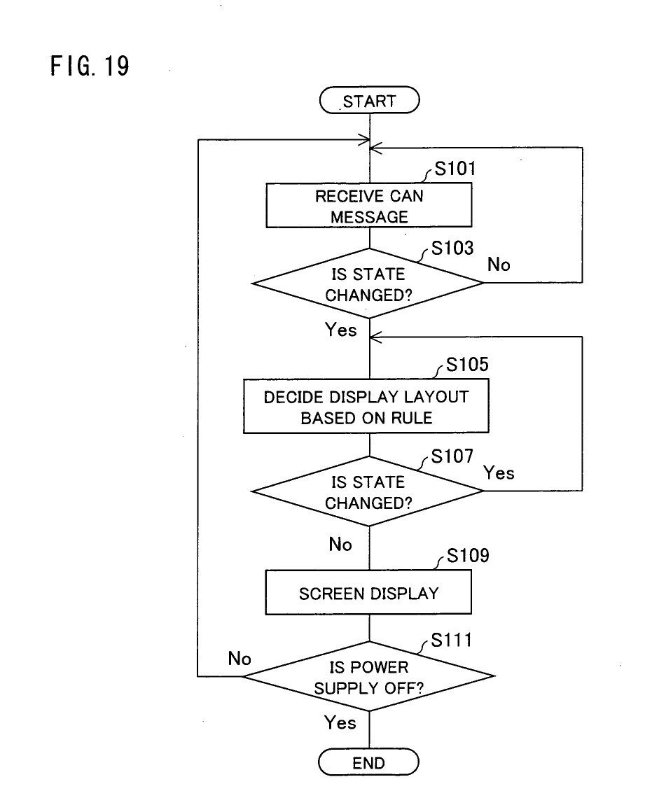

Note that, in the present embodiment, the layout decision rule has the tree structure. However, as shown in FIG. 16, the structure may be a network structure in general. In such a case, a traced route may be recorded for preventing an infinity rule.

5. Modification Example, etc

The blocks of the layout switching device 10, in particular, the state change judgment section 12, the disregard list comparing section 13, and the layout decision section 14, may be realized by either hardware logic or software with use of a CPU as described below.

That is, the layout switching device 10 includes a CPU (central processing unit) for executing instructions in a control program for realizing each function and memory devices (memory media) such as a ROM (read only memory) which contains the program; a RAM (random access memory) to which the program is loaded; and a memory which contains the program and various kinds of data. Further, the object of the present invention can be attained by (i) providing the layout switching device 10 with a computer-readable storage medium containing a control program code (an executable program, an intermediate code program, or a source program) for the layout switching device 10, which is software for realizing the functions, in order for the computer (or CPU, MPU) to retrieve and execute the program code contained in the storage medium.

The storage medium may be, for example: a tape such as a magnetic tape or a cassette tape; a disk including (i) a magnetic disk such as a floppy (registered trademark) disk or a hard disk and (ii) an optical disk such as a CD-ROM, an MO, an MD, a DVD, and a CD-R; a card such as an IC card (a memory card) or an optical card; or a semiconductor memory such as a mask ROM, an EPROM, an EEPROM, and a flash ROM.

The layout switching device 10 may be configured so as to be connectable to a communications network so that the program code is supplied over the communications network.

The communications network is not limited in particular. The communications network may be, for example: the internet, an intranet, an extranet, a LAN, an ISDN, a VAN, a CATV communications network, a virtual private network, a telephone line network, a mobile communications network, or a satellite communications network. Moreover, a transfer medium which makes up the communications network is not particularly limited, and may be, for example: a wired line such as an IEEE1394, a USB, an electric power line, a cable TV line, a telephone line, or an ADSL line; or wireless such as infrared radiation (IrDA, a remote controller), Bluetooth (registered trademark), 802.11, HDR, a mobile phone network, a satellite line, or a terrestrial digital network. Note that the present invention encompasses a carrier wave or data signal transmission in which the program code is embodied electronically.

As described above, the layout switching device of the present embodiment includes the disregard list storage section 16 for storing, for each of the display layouts, the disregard list indicating the types of state information for which switching of the display layouts is not required even when the state information is changed. Further, the disregard list comparing section 13 searches whether or not the type of the changed state information is included in the disregard list, in a case where the state information included in the CAN messages sent from the ECUs 51 . . . is changed. In a case where the type of the changed state information is found in the disregard list as a result of the search, the layout decision section 14 does not carry out the selection process of the display layout after switching, and disregards the change of the state information. Accordingly, execution of an unnecessary selection process of the display layout after switching is avoided, when the display layouts are not eventually required to be switched. This makes it possible to rapidly carry out the switching process of the display layouts in a case where switching of the layouts is really required.

Note that, in the present embodiment, the disregard list is prepared. This disregard list indicates the type of state information for which switching of the display layouts is not required event when the state information is changed. In a case where the type of the changed state information is not included in the disregard list, the layout decision section 14 carries out the selection process of the display layout after switching. However, the present invention is not limited to this configuration. The present invention may be configured such that (i) a consideration list is obtained, for each of the display layouts, by extracting only types of state information included in the conditional expression from the basis list and (ii) the layout decision section 14 carries out the selection process of the display layout after switching, in a case where the type of the changed state information is included in the consideration list. This configuration also provides an effect similar to the case where the disregard list is used.

Note however that, in comparison of the number of state information listed between in the disregard list and in the consideration list, the number in the disregard list is less than the consideration list in general. Accordingly, the disregard list requires less time for searching therein. Moreover, the types of state information listed in the disregard list include much state information which changes frequently, for example, the running speed and the engine revolutions. For the reasons above, the disregard list allows a more rapid judgment as to the necessity of switching of the display layouts.

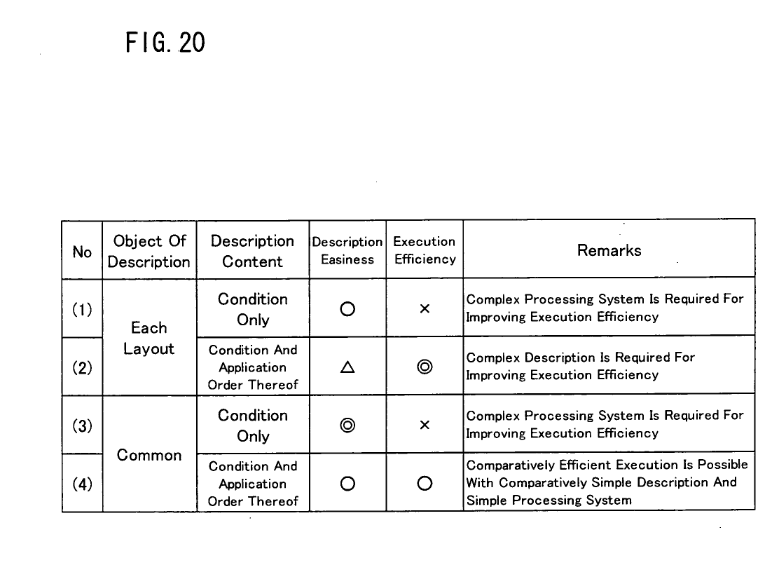

Moreover, in the present embodiment, the switching process of the display layouts is carried out by the method (4) shown in FIG. 20. However, the present invention is not limited to the method. It is possible to properly apply, to the method (2) shown in FIG. 20, the technical idea such that, in a case where the state information is changed, the necessity of switching of the layouts is judged based on whether or not the type of the changed state information is included in the disregard list or the consideration list. In this case, it is possible to use a layout decision rule which is similar to those shown in FIGS. 3 to 5.

However, as described in the present embodiment, according to the method in which (i) a single layout decision rule commonly applicable regardless of the current display layout is produced and (ii) both a condition and an application order of the condition are defined in the layout decision rule, the selection process of the display layout after switching can be efficiently carried out with comparatively a simple description and a simple processing system.

The present invention is not limited to the description of the embodiments above, but may be altered variously by a skilled person within the scope of the claims. The present invention encompasses an embodiment based on a proper combination of technical means variously changed in the technical scope of the present invention.

As described above, the layout switching device of the present invention includes: the type information storage section for storing, for each of the layouts, the type information indicating the type of state information; and the switching necessity judgment means for judging whether or not switching of the layouts is required based on whether or not the type of the changed state information is included in the type information corresponding to the current layout stored in the type information storage section, in a case where the state information is judged to be changed.

Moreover, the control method of the present invention includes the step of: judging, by the switching necessity judgment means of the layout switching device, whether or not switching of the layouts is required, based on whether or not the type of the changed state information is included in the type information corresponding to the current layout stored in the type information storage section for storing, for each of the layouts, the type information indicating the type of state information, in a case where the state information is judged to be changed.

Accordingly, as described above, it is possible to efficiently switch the layouts of the information screen shown to the operator of the moving object.

The embodiments and concrete examples of implementation discussed in the foregoing detailed explanation serve solely to illustrate the technical details of the present invention, which should not be narrowly interpreted within the limits of such embodiments and concrete examples, but rather may be applied in many changes within the spirit of the present invention, provided such changes do not exceed the scope of the patent claims set forth below.

### INDUSTRIAL APPLICABILITY

With the present invention, it is possible to efficiently switch the layouts of the information screen shown to the operator of the moving object. Accordingly, the present invention can be used for, for example, an information display system for a moving object which is capable of showing a user an information screen indicating various information of the moving object.

1. A layout switching device for switching, in accordance with a state of a moving object, layouts of an information screen shown to an operator of the moving object, comprising:
a state information acquiring means for acquiring state information indicating the state of the moving object;
a state change judgment means for judging whether or not the state information is changed, every time the state information acquiring means acquires the state information;
a type information storage section for storing, for each of the layouts, type information indicating a type of the state information;
a switching necessity judgment means for judging, based on whether or not a type of changed state information is included in the type information corresponding to a current layout, whether or not switching of the layouts is required, in a case where the state change judgment means judges that the state information is changed, the type information corresponding to the current layout being stored in the type information storage section;
a rule storage section for storing a layout decision rule for deciding a layout based on the state information; and
a layout decision means for deciding the layout after switching, in a case where the switching necessity judgment means judges that switching of the layouts is required, the layout being decided based on (i) the state information acquired by the state information acquiring means and (ii) the layout decision rule stored in the rule storage section.

2. The layout switching device as set forth in claim 1, wherein:
the type information storage section stores, for each of the layouts, type information indicating a type of state information for which switching of the layouts is not required; and
the switching necessity judgment means judges that switching of the layouts is required, in a case where the type of the changed state information is not included in the type information corresponding to the current layout.

3. The layout switching device as set forth in claim 1, wherein:
the layout decision rule is data in a tree structure;
the tree structure includes a root node and an intermediate node each of which indicates a condition of transition to a child node based on the state information;
the tree structure includes a leaf node which indicates a type of the layout after switching; and
the layout decision means decides the layout after switching by tracing the tree structure from the root node to the leaf node in accordance with the condition of transition indicated by each of the root node and the intermediate node, with use of the state information acquired by the state information acquiring means.

4. The layout switching device as set forth in claim 3, further comprising:
a basis information storage section;
a basis information producing means; and
a disregard information producing means, wherein:
the basis information producing means (i) produces a basis information list indicating respective types of state information which are referred to in the root node and the intermediate node, when the tree structure is traced from the root node to the leaf node, and (ii) stores the basis information list thus produced in the basis information storage section, in association with the type of the layout, the type of the layout being indicated by the leaf node;
the disregard information producing means (i) excludes, from all types of state information which the state information acquiring means is capable of acquiring, the respective types of state information which are included in the basis information list stored in the basis information storage section, thereby producing a disregard information list which indicates a type of state information for which switching of the layouts is not required even when the state information is changed, and (ii) stores, as the type information, the disregard information list thus produced in the type information storage section, in association with the type of the layout, the type of the layout being associated with the basis information list; and
the switching necessity judgment means judges that switching of the layouts is required, in a case where the type of the changed state information is not included in the type information corresponding to the current layout.

5. A screen generating device for a moving object, the screen generating device comprising:
a layout switching device as set forth in claim 1 which further includes an identifier outputting means for outputting an identifier indicating the type of the layout after switching, the layout after switching being decided by the layout decision means; and
a screen generating means for acquiring the identifier which is outputted by the identifier outputting means of the layout switching device, thereby generating the information screen so that the information screen has a layout corresponding to the identifier thus acquired.

6. An information display system for a moving object, the information display system comprising:
a screen generating device for the moving object as set forth in claim 5; and
a display device for displaying the information screen generated by the screen generating means of the screen generating device for the moving object.

7. A moving object comprising:
an information display system for the moving object as set forth in claim 6, wherein:
the display device is provided in a position that is visible from an operator's seat of the moving object.

8. A program for operating a layout switching device as set forth in claim 1, the program causing a computer to operate as all of the means.

9. A computer-readable storage medium storing a program as set forth in claim 8.

10. A control method of a layout switching device for switching, in accordance with a state of a moving object, layouts of an information screen shown to an operator of the moving object, the control method comprising the steps of:
acquiring, by a state information acquiring means of the layout switching device, state information indicating the state of the moving object;
judging, by a state change judgment means of the layout switching device, whether or not the state information thus acquired is changed, every time the state information is acquired in the step of acquiring the state information;
judging, by a switching necessity judgment means of the layout switching device, whether or not switching of the layouts is required, based on whether or not a type of changed state information is included in type information corresponding to a current layout, in a case where the state information is judged to be changed in the step of judging state change, the type information (i) indicating a type of the state information and (ii) being stored in a type information storage section for storing, for each of the layouts, the type information; and
deciding, by a layout decision means of the layout switching device, a layout after switching, in a case where it is judged, in the step of judging necessity of switching, that switching of the layouts is required, the layout being decided based on (i) the state information acquired in the step of acquiring the state information and (ii) a layout decision rule for deciding, based on the state information, the layout after switching, the layout decision rule being stored in a rule storage section for storing the layout decision rule.
